(19) United States
(12) Patent Application Publication
(10) Pub. No.: US 2025/0226588 A1
(43) Pub. Date: Jul. 10, 2025

(54) INTELLIGENT REFLECTING SURFACE

(71) Applicant: Japan Display Inc., Tokyo (JP)

(72) Inventors: Daiichi SUZUKI, Tokyo (JP); Shinichiro OKA, Tokyo (JP); Mitsutaka OKITA, Tokyo (JP)

(73) Assignee: Japan Display Inc., Tokyo (JP)

(21) Appl. No.: 19/089,239

(22) Filed: Mar. 25, 2025

Related U.S. Application Data
(63) Continuation of application No. PCT/JP2023/034478, filed on Sep. 22, 2023.

(30) Foreign Application Priority Data
Sep. 26, 2022 (JP) 2022-153030

(51) Int. Cl. H01Q 15/14; G02F 1/1362; G02F 1/1368

(52) U.S. Cl. CPC H01Q 15/148; G02F 1/136286; G02F 1/1368

(57) ABSTRACT

An intelligent reflecting surface including a plurality of reflective elements, a first signal line extending in a first direction and supplying a control signal, and a second signal line extending in a second direction different from the first direction and supplying a scanning signal, wherein, each of the plurality of reflective elements includes a plurality of patch electrodes electrically connected to each other and having different sizes, a conductive layer arranged at a distance from the plurality of patch electrodes and facing the plurality of patch electrodes, a liquid crystal layer arranged between each of the plurality of patch electrodes and the conductive layer, and a switching element connected to the first signal line and the second signal line and electrically connecting the plurality of patch electrodes and the first signal line based on the control signal.

### CROSS-REFERENCE TO RELATED APPLICATIONS

This application is a Continuation of International Patent Application No. PCT/JP2023/034478, filed on Sep. 22, 2023, which claims the benefit of priority to Japanese Patent Application No. 2022-153030, filed on Sep. 26, 2022, the entire contents of each are incorporated herein by reference.

### FIELD

One embodiment of the invention relates to an intelligent reflecting surface (a radio wave reflecting device).

### BACKGROUND

A phased array antenna device controls directivity with an antenna fixed by adjusting the amplitude and phase of a high-frequency signal applied to each of a plurality of antenna elements arranged in a plane. A phased array antenna device requires a phase shifter. For example, Japanese Laid-Open Patent Publication No. H11-103201 and Japanese Laid-Open Patent Publication No. 2019-530387 disclose a phased array antenna device using a phase shifter that utilizes a change in dielectric constant due to alignment states of liquid crystals.

### SUMMARY

An intelligent reflecting surface according to an embodiment of the present invention includes a first signal line extending in a first direction and supplying a control signal, a second signal line extending in a second direction different from the first direction and supplying a scanning signal, and a plurality of reflective elements, wherein each of the plurality of reflective elements includes a plurality of patch electrodes electrically connected to each other and having different sizes, a conductive layer arranged at a distance from the plurality of patch electrodes and facing the plurality of patch electrodes, a liquid crystal layer arranged between each of the plurality of patch electrodes and the conductive layer, and a switching element connected to the first signal line and the second signal line and electrically connecting the plurality of patch electrodes and the first signal line based on the control signal.

### BRIEF DESCRIPTION OF DRAWINGS

FIG. 1 is a plan view of a radio wave reflecting device of an embodiment of the present invention.

FIG. 2 is a plan view of a reflective element of an embodiment of the present invention.

FIG. 3 shows a cross-sectional view along a line A1-A2 in FIG. 2.

FIG. 4A is a diagram for explaining a state in which no voltage is applied between a patch electrode and a conductive layer of a reflective element.

FIG. 4B is a diagram for explaining a state in which a control signal is applied to the patch electrode of the reflective element.

FIG. 5 is a cross-sectional view of a part of a reflective element according to an embodiment of the present invention.

FIG. 6 is a circuit diagram showing a configuration of a reflective element according to a modification.

FIG. 7 is a circuit diagram showing a configuration of a reflective element according to a modification.

### DESCRIPTION OF EMBODIMENTS

Although fifth generation communication (5G) is currently being popularized, a high-frequency millimeter wave band (24 GHz to 29 GHz) used for 5G high-speed and large-capacity communication has a large information capacity, but has a high linearity and a short arrival distance. As a result, radio waves are shielded in areas such as those in the shadow of buildings, resulting in poor communication quality. Adding more radio wave base stations and relay equipment, and the like, would incur costs associated with the installation, and it would be necessary to secure a location for the installation. Therefore, it has been proposed to improve communication quality while reducing costs by installing a radio wave reflecting device that reflects radio waves toward areas where they are difficult to reach.

In a radio wave reflecting device using a material with a constant dielectric constant, a direction of reflection is fixed. On the other hand, in a radio wave reflecting device that uses a liquid crystal material as a dielectric, a direction of reflection can be changed by adjusting a voltage applied to the liquid crystal to change a dielectric constant of the liquid crystal. In the case of the radio wave reflecting device that uses the liquid crystal material as the dielectric, if the amount of phase difference is insufficient, the variable range of a reflection direction that reflects radio waves is limited. Therefore, a device has been devised to increase the variable range of the reflection direction by arranging patch electrodes of different sizes.

Even though the same voltage is applied to patch electrodes of different sizes, one switching device is provided per patch electrode. This results in unnecessary power consumption and extra voltage output from the IC.

In view of these problems, the present invention provides a radio wave reflecting device with reduced power consumption. The radio wave reflecting device includes a radio wave reflector (hereafter referred to as a reflector). The reflector may be described as an intelligent reflecting surface.

Embodiments of the present invention will be described below with reference to the drawings and the like. However, the invention can be implemented in many different aspects and is not to be interpreted as limited to the description of the following embodiments. The drawings may be schematically represented in terms of width, thickness, shape, and the like, of each part compared to the actual form in order to make the description clearer, but the drawings are only an example and does not limit the interpretation of the invention. In addition, in this specification and in each figure, elements similar to those previously described in already described figures may be given the same reference sign (or a reference sign with a, b, or the like after a number), and duplicate explanations may be omitted. Furthermore, the terms “first” and “second” appended to each element are signs of convenience used to distinguish each element, and have no further meaning unless otherwise explained.

In the case where a component or area is said to be “above (or below)” another component or area, unless otherwise specified, this includes not only a case where it is directly above (or below) the other component or area, but also a case where it is above (or below) the other component or area, that is, a case where it contains another component above (or below) the other component or area.

### Radio Wave Reflecting Device

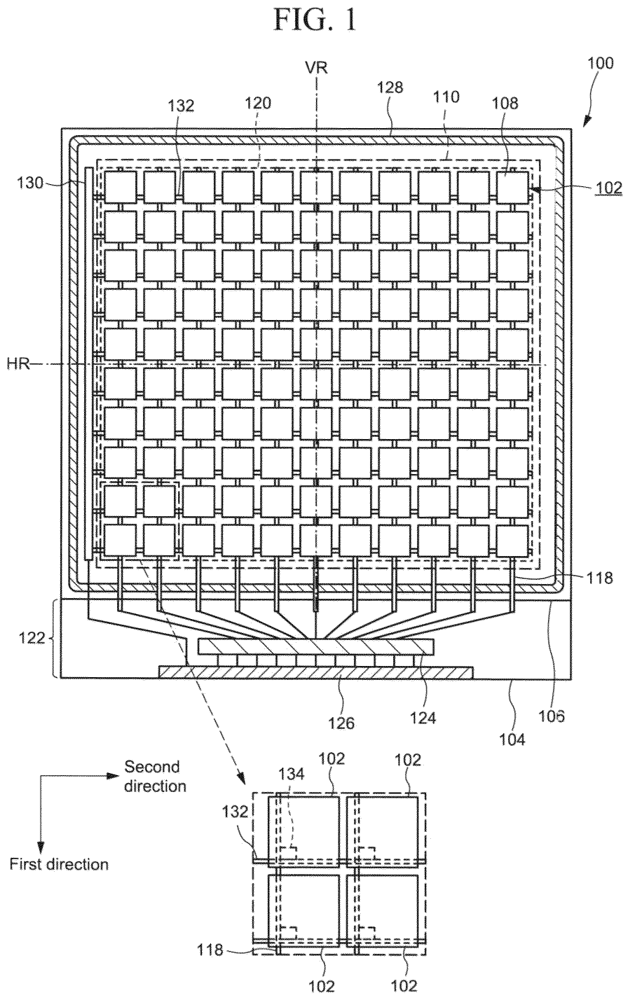

FIG. 1 is a plan view of a radio wave reflecting device 100. The radio wave reflecting device 100 has a reflector 120. The reflector 120 is composed of a plurality of reflective elements 102. The plurality of reflective elements 102 is arranged, for example, in a first direction (for example, a column direction) and in a second direction (for example, a row direction) different from the first direction. The reflective elements 102 are arranged so that a plurality of patch electrodes 108, which will be described below, face a plane of incidence of radio waves. The reflector 120 is flat, and the plurality of patch electrodes 108 of each reflective element 102 are arranged in the flat plane in a matrix along the first and second directions.

The intelligent reflecting device 100 has a structure in which the plurality of reflective elements 102 is integrated on a single dielectric substrate (a dielectric layer) 104. As shown in FIG. 1, the radio wave reflecting device 100 has a structure in which the dielectric substrate (the dielectric layer) 104 on which the plurality of patch electrodes 108 (described below) is provided, and an opposing substrate 106 on which a conductive layer 110 is provided are arranged so that the patch electrodes 108 and the conductive layer 110 face each other, and a liquid crystal layer (not shown) is provided between the two substrates. The reflector 120 is formed in a region where the plurality of patch electrodes 108 and the conductive layer 110 are overlap each other. The dielectric substrate (the dielectric layer) 104 and the opposing substrate 106 are attached to each other with a sealing material 128, and the liquid crystal layer is provided in a region inside the sealing material 128.

In addition to a region facing the opposing substrate 106, the dielectric substrate (the dielectric layer) 104 has a peripheral region 122 that extends outward from the opposing substrate 106. The peripheral region 122 is provided with a first driving circuit 124 and a terminal portion 126. The first driving circuit 124 outputs a control signal to the patch electrode 108. The terminal portion 126 is a region forming a connection with an external circuit, and for example, a flexible printed circuit board, not shown, is connected to the terminal portion 126. A signal controlling the first driving circuit 124 is input to the terminal portion 126.

As described above, the plurality of patch electrodes 108 is arranged on the dielectric substrate (the dielectric layer) 104 in the first direction (the column direction) and the second direction (the row direction). A plurality of first signal lines 118 extending in the first direction and a plurality of second signal lines 132 extending in the second direction are arranged on the dielectric substrate (the dielectric layer) 104. The plurality of first signal lines 118 and the plurality of second signal lines 132 are arranged to intersect each other with an insulation layer (not shown) interposed therebetween. The plurality of first signal lines 118 is connected to the first driving circuit 124, and the plurality of second signal lines 132 are connected to a second driving circuit 130. The first driving circuit 124 outputs a control signal and the second driving circuit 130 outputs a scanning signal. The first signal line 118 is electrically connected to the plurality of reflective elements 102 arranged in the first direction (the column direction). In other words, the plurality of reflective elements 102 arranged in the first direction (the column direction) are connected by the first signal line 118. The reflector 120 has a configuration in which a plurality of reflective element arrays in a line connected by the first signal line 118 is arranged in the second direction (the row direction).

FIG. 1 shows an enlarged inset of an arrangement of four reflective elements 102, two first signal lines 118 and the second signal line 132. A switching element 134 is provided for each of the four reflective elements 102. Switching (on/off) of the switching element 134 is controlled by a scanning signal applied to the second signal line 132. The reflective element 102 whose switching element 134 is turned on conducts with the first signal line 118 and is applied with the control signal. The switching element 134 is formed, for example, by a thin-film transistor. According to this configuration, the plurality of patch electrodes 108 arranged in the second direction (the row direction) can be selected for each row, and control signals of different voltage levels can be applied to each row.

The radio wave reflecting device 100 shown in FIG. 1 can control a direction of travel of the reflected wave, which is irradiated to the reflector 120, in a left-right direction of the drawing, centered on a reflection axis VR parallel to the first direction (the column direction), and can also control a direction of travel of the reflected wave in a vertical direction of the drawing centered on a reflection axis HR parallel to the second direction (the row direction). In other words, since the radio wave reflecting device 100 has the reflection axis VR parallel to the first direction (the column direction) and the reflection axis HR parallel to the second direction (the row direction), a reflection angle can be controlled in a direction with the reflection axis VR as a rotation axis and a direction with the reflection axis HR as a rotation axis.

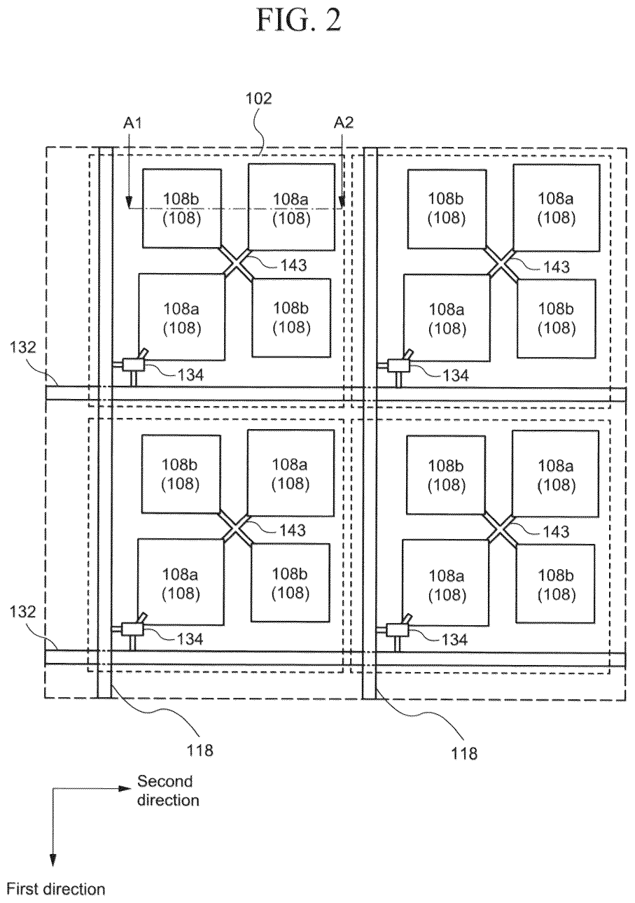

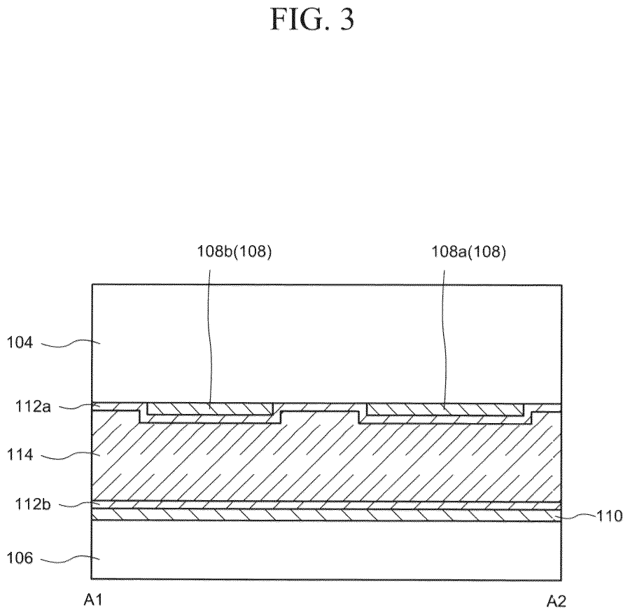

FIG. 2 is a plan view of the reflective element 102. FIG. 3 is a cross-sectional view along a line A1-A2 in FIG. 2. Referring to FIG. 2 and FIG. 3, the reflective element 102 includes the dielectric substrate 104, the opposing substrate 106, the plurality of patch electrodes 108 (108a, 108b), the conductive layer 110, a liquid crystal layer 114, a first alignment film 112a, and a second alignment film 112b. The dielectric substrate 104 can be regarded as a dielectric layer as it forms one layer in the reflective element 102. The plurality of patch electrodes 108 is arranged on the dielectric substrate (the dielectric layer) 104, and the conductive layer 110 is arranged on the opposing substrate 106. The first alignment film 112a is arranged on the dielectric substrate (the dielectric layer) 104 to cover the plurality of patch electrodes 108, and the second alignment film 112b is arranged on the opposing substrate 106 to cover the conductive layer 110. The plurality of patch electrodes 108 and the conductive layer 110 are arranged to face each other, and the liquid crystal layer 114 is arranged between them. The first alignment film 112a is interposed between the plurality of patch electrodes 108 and the liquid crystal layer 114, and the second alignment film 112b is interposed between the conductive layer 110 and the liquid crystal layer 114.

Although not shown in the figure, the dielectric substrate (the dielectric layer) 104 and the opposing substrate 106 are attached to each other by a sealing material. The dielectric substrate (the dielectric layer) 104 and the opposing substrate 106 are arranged opposite each other with a gap, and the liquid crystal layer 114 is arranged within a region enclosed by the sealing material. The liquid crystal layer 114 is provided to fill the gap between the dielectric substrate (the dielectric layer) 104 and the opposing substrate 106. The gap between the dielectric substrate (the dielectric layer) 104 and the opposing substrate 106 may be 20 μm to 100 μm, for example, 50 μm. Since the patch electrode 108, the conductive layer 110, the first alignment film 112a, and the second alignment film 112b are arranged between the dielectric substrate (the dielectric layer) 104 and the opposing substrate 106, to be precise, a distance between the first alignment film 112a arranged on the dielectric substrate 104 and second alignment film 112b arranged on the opposing substrate 106 is a thickness of the liquid crystal layer 114.

In addition, although not shown in the figure, a spacer may be provided between the dielectric substrate (the dielectric layer) 104 and the opposing substrate 106 to keep the spacing constant.

A control signal that controls the alignment of liquid crystal molecules in the liquid crystal layer 114 is applied to the patch electrode 108 via the first signal line 118. The control signal is a DC voltage signal or a polarity reversal signal in which positive and negative DC voltages are alternately reversed. The conductive layer 110 is applied with a voltage at a ground level or an intermediate level between the polarity reversal signals. When the control signal is applied to the patch electrode 108, the alignment state of the liquid crystal molecules in the liquid crystal layer 114 changes. A liquid crystal material having dielectric anisotropy is used for the liquid crystal layer 114. For example, nematic liquid crystal, smectic liquid crystal, cholesteric liquid crystal, and discotic liquid crystal can be used as the liquid crystal layer 114. The liquid crystal layer 114 having dielectric anisotropy has a dielectric constant that changes due to changes in the alignment state of the liquid crystal molecules. The dielectric constant of the liquid crystal layer 114 can be changed by a control signal applied to the patch electrode 108, thereby allowing the reflective element 102 to delay the phase of the reflected wave when reflecting radio waves.

Frequency bands of radio waves reflected by the reflective element 102 are a very high frequency (VHF: Very High Frequency) band, an Ultra high frequency (UHF: Ultra High Frequency) band, a microwave (SHF: Super High Frequency) band, submillimeter wave (THF: Tremendously High Frequency) and millimeter wave (EHF: Extra High Frequency) bands. Although the alignment of the liquid crystal molecules in the liquid crystal layer 114 changes in response to the control signal applied to the patch electrode 108, it hardly follows the frequency of the radio waves irradiated to the patch electrode 108. Therefore, the reflective element 102 can control the phase of the reflected radio waves without being affected by the radio waves.

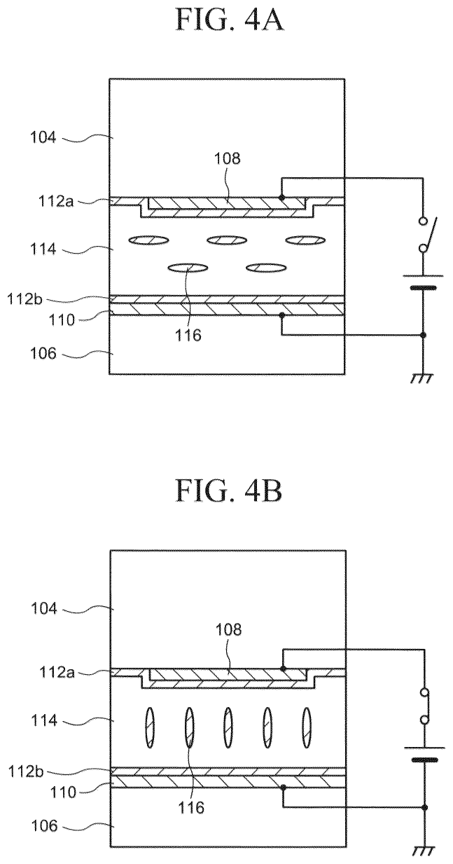

FIG. 4A shows a state in which no voltage is applied between the patch electrode 108 and the conductive layer 110 (referred to as a “first state”). FIG. 4A shows the case where the first alignment film 112a and the second alignment film 112b are horizontally aligned films. A long axis of the liquid crystal molecules 116 in the first state is oriented horizontally relative to surfaces of the patch electrode 108 and the conductive layer 110 by the first alignment film 112a and the second alignment film 112b.

FIG. 4B shows a state in which a control signal (voltage signal) is applied to the patch electrode 108 (referred to as a “second state”). In the second state, the liquid crystal molecules 116 are oriented with their long axis perpendicular to the surfaces of the patch electrode 108 and the conductive layer 110 under an action of an electric field. An angle at which the long axis of the liquid crystal molecules 116 is oriented can also be oriented in a direction intermediate between the horizontal and vertical directions by adjusting a magnitude of the control signal applied to the patch electrode 108 (a magnitude of the voltage between the counter electrode and the patch electrode).

If the liquid crystal molecules 116 have positive dielectric anisotropy, the dielectric constant is larger in the second state than in the first state. Further, if the liquid crystal molecules 116 have negative dielectric anisotropy, the apparent dielectric constant is smaller in the second state than in the first state. The liquid crystal layer 114 having dielectric anisotropy can be regarded as a variable dielectric layer. The reflective element 102 can use the dielectric anisotropy of the liquid crystal layer 114 to control the phase of the reflected wave. Specifically, the reflective element 102 can be controlled to delay or not delay the phase of the reflected wave.

When reflecting radio waves in a given direction, it is preferable that the reflective element 102 attenuate the amplitude of the reflected radio waves as little as possible. As is clear from the structure shown in FIG. 3, when radio waves propagating in the air are reflected by the reflective element 102, the radio wave passes through the dielectric substrate (the dielectric layer) 104 twice. The dielectric substrate (the dielectric layer) 104 is formed of a dielectric material such as glass or resin, for example. Since the phase velocity of radio waves changes as they pass through the dielectric material, a thickness of the dielectric substrate (the dielectric layer) 104 is adjusted in order to prevent the amplitude of the reflected wave from being attenuated. In addition, the thickness of the dielectric substrate (the dielectric layer) 104 can be defined as a length from a surface of the patch electrode 108 side of the liquid crystal layer 114 to an opposite side of the dielectric substrate (the dielectric layer) 104 where the patch electrode 108 is not provided.

Returning to FIG. 2, the reflective element 102 includes a plurality of patch electrodes 108. The plurality of patch electrodes 108 are electrically connected to each other via a connection wiring (a third connection wiring) 143. As an example, this embodiment describes an aspect in which the reflective element 102 includes four patch electrodes 108. In this embodiment, in the reflective element 102, the plurality of patch electrodes 108 includes two first patch electrodes 108a having a relatively large size and two second patch electrodes 108b having a relatively small size. A size of the first patch electrodes 108a should be equal to or greater than 107% and less than or equal to 140% of a size of the second patch electrodes 108b.

A shape of each patch electrode 108 is described below. The shape of the patch electrode 108 should have rotational symmetry relative to a center of the patch electrode 108. For example, the shape of the patch electrode 108 may be a four-fold rotational symmetric shape and may have a square or diamond shape in a plan view. The four-fold rotational symmetric shape may be a square with each vertex beveled or a rectangle with each vertex rounded. Further, the shape of the patch electrode 108 may be circular. In this embodiment, the case in which the shape of the patch electrode 108 is square in the plan view is shown. The shape of the patch electrode 108 has rotational symmetry relative to the center of the patch electrode 108, thereby reducing the anisotropy relative to the reflection of radio waves for vertical and horizontal polarization of the incoming radio waves. That is, bias of the vertical and horizontal polarization can be suppressed and the vertical and horizontal polarization can be reflected uniformly. In the case of reflecting radio waves in the millimeter wave band of 24 GHz to 29 GHz, if the shape of the patch electrode 108 is square, the size of the patch electrode 108 may be about 3.0 mm×3.0 mm to 4.5 mm×4.5 mm.

In the first patch electrode 108a and the second patch electrode 108b arranged along the first direction, a center of the first patch electrode 108a and a center of the second patch electrode 108b are aligned in a straight line in the first direction. In the first patch electrode 108a and the second patch electrode 108b arranged along the second direction, the center of the first patch electrode 108a and the center of the second patch electrode 108b are aligned in a straight line in the second direction.

As mentioned above, in this embodiment, each reflective element 102 includes the plurality of patch electrodes 108 (first patch electrodes 108a and second patch electrodes 108b) of different sizes, which can suppress the attenuation of the amplitude of the reflected wave, expand the amount of phase change of the reflected wave, and increase the variable range of direction to reflect radio waves. In the following description, the first patch electrode 108a and the second patch electrode 108b will simply be referred to as the patch electrode 108 in the case where there is no need to distinguish between them.

In the reflective element 102, the two first patch electrodes 108a are arranged on an abbreviated diagonal line with respect to each other. Similarly, in the reflective element 102, the two second patch electrodes 108b are arranged on an abbreviated diagonal line with respect to each other. It is preferable that the two first patch electrodes 108a and the two second patch electrodes 108b are each positioned so that in the case where the reflective element 102 is rotated 90°, that is, in the case the intelligent reflecting device 100 is rotated 90°, positions of the first patch electrodes 108a and the second patch electrodes 108b are symmetrical before and after rotation. Symmetry in the positioning of the first patch electrodes 108a and the second patch electrodes 108b in the reflective element 102 can balance the polarization of the reflected wave when the reflective element 102 reflects radio waves.

As mentioned above, in the reflective element 102, the two first patch electrodes 108a and the two second patch electrodes 108b are electrically connected to each other via the connection wiring 143. In other words, the two first patch electrodes 108a and the two second patch electrodes 108b are shorted to each other. Therefore, the same voltage control signal is applied to the two first patch electrodes 108a and the two second patch electrodes 108b.

There is no particular limitation on the shape of the conductive layer 110, which may have a shape that extends over the entire surface of the opposing substrate 106 so that it has a larger area than the patch electrode 108.

In FIG. 2, of the two first patch electrodes 108a in the reflective element 102, one of the first patch electrodes 108a arranged at the lower left in the figure is connected to the switching element 134. A control signal is applied to the first patch electrode 108a connected to the switching element 134 via the corresponding first signal line 118. The applied control signal is applied to the other first patch electrode 108a and the two second patch electrodes 108b via the connection wiring 143. The connection wiring 143 connects one first patch electrode 108a connected to the switching element 134 to the other first patch electrode 108a and the two second patch electrodes 108b. The connection wiring 143 may have a cross shape made up of two extending portions inclined at a predetermined angle relative to the first and second directions. An angle of the extending portions relative to the first and second directions may be ±about 45°. The shape of the connection wiring 143 is not limited to a cross shape. The patch electrode 108 connected to the switching element 134 is not limited to the first patch electrode 108a.

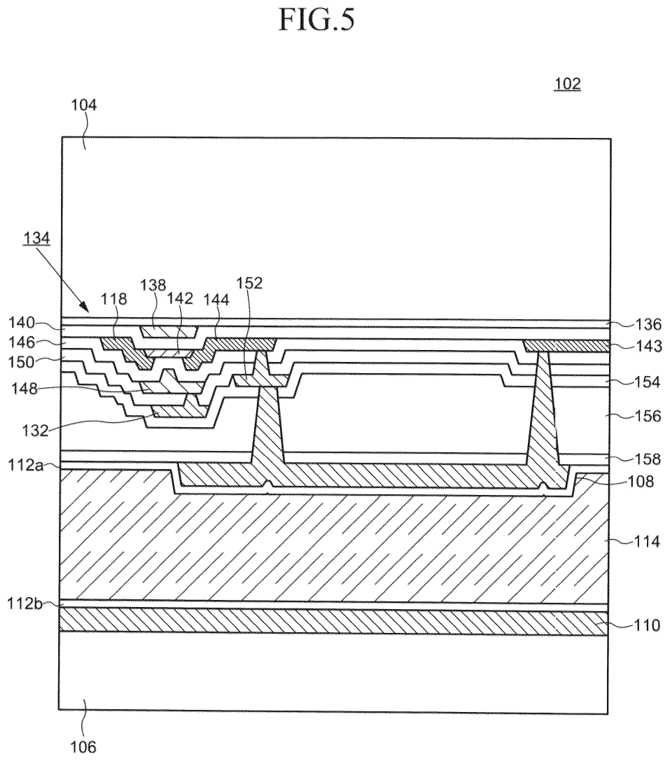

FIG. 5 shows an example of a cross-sectional structure of a part of the reflective element 102, including the patch electrode 108 to which the switching element 134 is connected. The switching element 134 is arranged on the dielectric substrate (the dielectric layer) 104. The switching element 134 is a thin film transistor and has a stacked structure of a first gate electrode 138, a first gate insulation layer 140, a semiconductor layer 142, a second gate insulation layer 146, and a second gate electrode 148. An undercoat layer 136 may be provided between the first gate electrode 138 and the dielectric substrate (the dielectric layer) 104. The first signal line 118 is provided between the first gate insulating layer 140 and the second gate insulating layer 146. The first signal line 118 is provided in contact with the semiconductor layer 142. The first connection wiring 144 and the third connection wiring (a connection wiring) 143 are arranged in the same layer as the conductive layer forming the first signal line 118. The first connection wiring 144 is provided in contact with the semiconductor layer 142. A connection structure of the first signal line 118 and the first connection wiring 144 relative to the semiconductor layer 142 has a structure in which one wiring is connected to a source of the transistor and the other wiring is connected to a drain of the transistor.

A first interlayer insulating layer 150 is provided to cover the switching element 134 and the third connection wiring (the connection wiring) 143. The second signal line 132 is arranged on the first interlayer insulating layer 150. The second signal line 132 is connected to the second gate electrode 148 through a contact hole formed in the first interlayer insulation layer 150. Although not shown in the figure, the first gate electrode 138 and the second gate electrode 148 are electrically connected to each other in a region that does not overlap the semiconductor layer 142. On the first interlayer insulating layer 150, a second connection wiring 152 is provided in the same conductive layer as the second signal line 132. The second connection wiring 152 is connected to the first connection wiring 144 through a contact hole formed in the first interlayer insulating layer 150.

A second interlayer insulating layer 154 is provided to cover the second signal line 132 and the second connection wiring 152. Furthermore, a planarization layer 156 is provided to fill steps of the switching element 134. By providing the planarization layer 156, the patch electrode 108 can be formed without being affected by the arrangement of the switching element 134. A passivation layer 158 is arranged on the flat surface of the planarization layer 156. The patch electrodes 108 are arranged on the passivation layer 158. The patch electrode 108 is connected to the second connection wiring 152 via a contact hole through the passivation layer 158, the planarization layer 156, and the second interlayer dielectric layer 154. In addition, the patch electrode 108 is also connected to the third connection wiring (the connection wiring) 143 via a contact hole through the passivation layer 158, the planarization layer 156, the second interlayer insulating layer 154, the first interlayer insulating layer 150, and the second gate insulating layer 146. The third connection wiring (the connection wiring) 143 is extended and connected to other patch electrodes 108 (not shown in FIG. 5) included in the same reflective element 102 as the patch electrode 108 to which the switching element 134 is connected. The first alignment film 112a is arranged on the patch electrode 108.

The opposing substrate 106 is provided with the conductive layer 110 and the second alignment film 112b, as shown in FIG. 3. A surface of the dielectric substrate (the dielectric layer) 104 on which the switching element 134 and the patch electrodes 108 are provided is arranged so as to face a surface of the opposing substrate 106 on which the conductive layer 110 is provided, and the liquid crystal layer 114 is provided between them. A thickness of the dielectric substrate (the dielectric layer) 104 can be a length from a surface of the patch electrodes 108 on the liquid crystal layer 114 side to a surface of the dielectric substrate (the dielectric layer) 104 opposite to a surface on which the patch electrode 108s are provided. In this case, the thickness of the dielectric substrate (the dielectric layer) 104 can take into consideration at least one insulating layer (the undercoat layer 136, the first gate insulating layer 140, the second gate insulating layer 146, the first interlayer insulating layer 150, the second interlayer insulating layer 154, the planarization layer 156, and the passivation layer 158) between the patch electrodes 108 and/or the dielectric substrate (the dielectric layer) 104.

Each layer formed on the dielectric substrate (the dielectric layer) 104 is formed using the following materials. The undercoat layer 136 is formed, for example, with a silicon oxide film. The first gate insulating layer 140 and the second gate insulating layer 146 are formed, for example, with a silicon oxide film or a layered structure of a silicon oxide film and a silicon nitride film. The semiconductor layer 142 is formed of a silicon semiconductor such as amorphous silicon and polycrystalline silicon, an oxide semiconductor including a metal oxide such as indium oxide, zinc oxide, and gallium oxide, or the like. The first gate electrode 138 and the second gate electrode 148 may comprise, for example, molybdenum (Mo), tungsten (W), or alloys thereof. The first signal line 118, the second signal line 132, the first connection wiring 144, the second connection wiring 152, and the third connection wiring 143 are formed using a metal material such as titanium (Ti), aluminum (Al), and molybdenum (Mo). For example, they may be formed of a titanium (Ti)/aluminun (Al)/titanium (Ti) laminate structure or a molybdenum (Mo)/aluminun (Al)/molybdenum (Mo) laminate structure. Further, to prevent radio interference by the third connection wiring 143, a line width of the third connection wiring 143 should be 10 μm or less. The planarization layer 156 is formed of a resin material such as acrylic, polyimide, and the like. The passivation layer 158 is formed of, for example, a silicon nitride film. The patch electrodes 108 and the conductive layer 110 are formed of a metal film such as aluminum (Al), copper (Cu) and the like, or a transparent conductive film such as indium tin oxide (ITO) and the like.

As shown in FIG. 5, by connecting the second signal line 132 to a gate of the transistor used as the switching element 134, connecting the first signal line 118 to one of the source and drain of the transistor, and connecting the patch electrode 108 to the other of the source and drain, a predetermined reflective element 102 can be selected from a plurality of the reflective elements 102 arranged in a matrix, and a control signal can be applied to the patch electrodes 108 of the selected reflective element. The control signal can then be applied to each of the plurality of reflective elements 102 arrayed along the first direction (the column direction) or each of the reflective elements 102 arrayed along the second direction (the row direction) by the switching element 134 provided for each individual reflective element 102 in the reflector 120. For example, when the reflector 120 is upright, a direction of reflection of the reflected wave can be controlled in the left-right direction and the vertical direction.

In FIG. 5, although a case is described in which the third connection wiring (the connection wiring) 143 is formed in the same layer as the conductive layer forming the first signal line 118 and the first connection wiring 144, the present embodiment is not limited to this. For example, the third connection wiring (the connection wiring) 143 may be formed in the same layer as the conductive layer forming the second signal line 132 and the second connection wiring 152.

Conventionally, one switching element is provided per patch electrode, and a scanning signal is applied from a corresponding second signal line (a scanning line). In this embodiment, the plurality of patch electrodes 108 (two first patch electrodes 108a and two second patch electrodes 108b) included in one reflective element 102 are electrically connected to each other by the connection wiring 143. Therefore, only one switching element 134 is needed to apply the control signal to the plurality of patch electrodes 108 included in one reflective element 102. Therefore, in this embodiment, the number of switching elements 134 directly connected to the patch electrodes 108 in one reflective element 102 can be reduced than before. By reducing the number of switching elements 134 directly connected to the patch electrode 108, the number of second signal lines for applying scanning signals to the switching elements 134 can also be reduced. As a result, unnecessary power consumption and extra voltage output from external ICs can be reduced.

The radio wave reflecting device 100 can be used to reflect radio waves in 24 GHz to 53 GHZ (millimeter wave band), such as the 28 GHZ, 39 GHz, and 47 GHz wave bands, in the desired direction.

### Modifications

Although one embodiment of the present disclosure has been described above, the invention can be implemented in various forms as follows.

(1) In the embodiment described above, as shown in FIG. 2, an example is described in which the switching element 134 connecting to the patch electrodes 108 is arranged at the lower left in the figure. However, the position of the switching element 134 is not limited to this. For example, the switching element 134 may be arranged in a center of the reflective element 102.

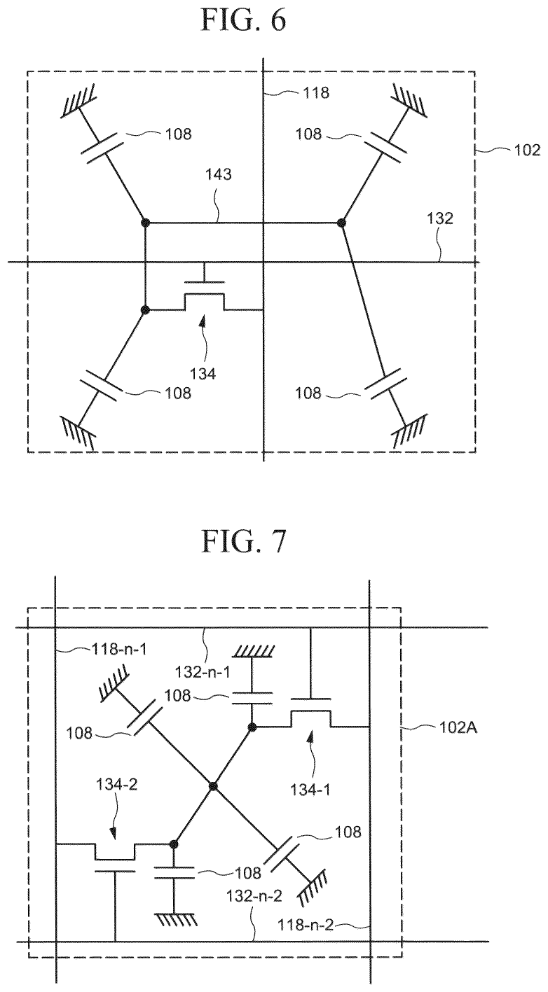

FIG. 6 shows a circuit diagram of the reflective element 102 for this modification. As shown in FIG. 6, in the reflective element 102, the switching element 134 may be arranged in an abbreviated central position. In this case, the connection wiring (third connection wiring) 143 connecting between the patch electrodes 108 may be arranged in the same layer as the patch electrodes 108. The patch electrode 108 directly connected to the switching element 134 may be a first patch electrode 108a or a second patch electrode 108b.

(2) In the embodiment described above, one switching element 134 is provided for every one reflective element 102. However, the number of switching elements 134 is not limited to one.

FIG. 7 is a circuit diagram of a reflective element 102A for this modification. As shown in FIG. 7, the reflective element 102A may have two switching elements 134-1 and 134-2. In this case, the two switching elements 134-1 and 134-2 are directly connected to two patch electrodes 108 located diagonally opposite each other in the reflective element 102A. The patch electrodes 108 to which the switching elements 134-1 and 134-2 connect may be the first patch electrode 108a or the second patch electrode 108b. In the case of applying a control signal to the patch electrodes 108 of the reflective element 102A, scanning signals are simultaneously applied to the two switching elements 134-1 and 134-2 via two second signal lines 132-n-1 and 132-n-2 corresponding to the reflective element 102A. When the scanning signals are applied and the switching elements 134-1 and 134-2 become conductive, control signals of the same potential are supplied from two first signal lines 118-n-1 and 118-n-2 corresponding to the reflective element 102A to the patch electrodes 108 connected thereto via the switching elements 134-1 and 134-2, respectively. The patch electrode 108 directly connected to the switching elements 134-1 and 134-2 may be the first patch electrode 108a or the second patch electrode 108b.

In this modification, in the reflective element 102A, the two switching elements 134-1 and 134-2 are connected to two patch electrodes 108 located diagonally opposite each other. Therefore, the number of switching elements used in the reflective element 102A can be reduced than before, while the potential of four patch electrodes 108 to which the control signal is applied can be made closer to equipotential in the reflective element 102A than before, thereby improving symmetry.

The various configurations of the radio wave reflecting device and reflective element exemplified as an embodiment of the present invention can be combined as appropriate as long as they do not contradict each other. In addition, any addition, deletion, or design change of components, or any addition, omission, or change of conditions of processes, made by a person skilled in the art based on the radio wave reflecting device and reflective element disclosed in this specification and the drawings, is also included in the scope of the invention, as long as it has the gist of the invention.

Other effects different from those brought about by the embodiments disclosed herein, which are obvious from the description herein or which can be easily predicted by those skilled in the art, are naturally understood to be brought about by the present invention.

What is claimed is:

1. An intelligent reflecting surface comprising:
a first signal line extending in a first direction and supplying a control signal;
a second signal line extending in a second direction different from the first direction and supplying a scanning signal; and
a plurality of reflective elements,
wherein,
each of the plurality of reflective elements includes:
a plurality of patch electrodes electrically connected to each other and having different sizes;
a conductive layer arranged at a distance from the plurality of patch electrodes and facing the plurality of patch electrodes;
a liquid crystal layer arranged between each of the plurality of patch electrodes and the conductive layer; and
a switching element connected to the first signal line and the second signal line and electrically connecting the plurality of patch electrodes and the first signal line based on the control signal.

2. The intelligent reflecting surface according to claim 1, wherein
the plurality of patch electrodes includes a plurality of first patch electrodes having a relatively large size and a plurality of second patch electrodes having a relatively small size, and
the number of the plurality of first patch electrodes is the same as the number of the plurality of second patch electrodes.

3. The intelligent reflecting surface according to claim 2, wherein
the plurality of patch electrodes includes two of the first patch electrodes and two of the second patch electrodes,
one of the first patch electrodes is adjacent to one of the second patch electrodes in the first direction and adjacent to the other one of the second patch electrodes in the second direction, and
the other one of the first patch electrodes is adjacent to the other one of the second patch electrodes in the first direction and adjacent to the one of second patch electrodes in the second direction.

4. The intelligent reflecting surface according to claim 2 wherein a size of the first patch electrode is equal to or greater than 107% and less than or equal to 140% of a size of the second patch electrode.

5. The intelligent reflecting surface according to claim 1 further comprising a connection wiring electrically connecting the plurality of patch electrodes to each other, wherein
the connection wiring is inclined at a predetermined angle relative to the first direction and the second direction.

6. The intelligent reflecting surface according to claim 1, wherein the plurality of patch electrodes is configured to reflect radio waves in a frequency band of 24 GHz to 29 GHz.

7. The intelligent reflecting surface according to claim 3, wherein the switching element includes a first switching element electrically connecting the one of the first patch electrodes to the first signal line and a second switching element electrically connecting the other one of the first patch electrodes to the first signal line.
